(19) United States
(12) Patent Application Publication
(10) Pub. No.: US 2007/0086524 A1
(43) Pub. Date: Apr. 19, 2007

(54) METHOD FOR TRANSFORM-DOMAIN ROUNDING IN A DECODER AND VIDEO DECODER THEREOF

(76) Inventors: Chen Chen, Taipei (TW); Ping-Hao Wu, Taipei City (TW); Homer H. Chen, Tai-Chung City (TW)

Correspondence Address: NORTH AMERICA INTELLECTUAL PROPERTY CORPORATION, P.O. BOX 506, MERRIFIELD, VA, 22116, US

(21) Appl. No.: 11/163,280

(22) Filed: Oct. 13, 2005

(51) Int. Cl. H04N 11/02; H04N 11/04

(52) U.S. Cl. 375/240.16; 375/240.24; 375/240.18

(57) ABSTRACT

A method for transform domain rounding in a decoder includes performing transform-domain motion compensation on a block according to a motion vector to generate a motion-compensated block, determining a transform-domain offset with reference to the motion vector, adding the transform-domain offset to the motion-compensated block to obtain an addition result, and outputting the addition result as a rounded reference block.

### BACKGROUND OF THE INVENTION

1. Field of the Invention

The present invention relates to digital communications, and more specifically, to a method for transform-domain rounding in a decoder and a video decoder thereof.

2. Description of the Prior Art

Video coding is widely used in multimedia electronic devices. Video coding systems normally apply a discrete cosine transform (DCT) to video signals to achieve energy compaction, i.e. compression. Image operations, such as motion compensation and down sampling, have counterparts in the transform domain and so can be performed without decoding the compressed video back into the pixel domain. This can help meet the demands of quality of service (QoS) and power consumption requirements in the ever popular multimedia-capable mobile devices such as mobile phones, PDAs, and portable computers.

Please refer to FIG. 1, which is a block diagram of a conventional decoder 100 for motion compensation in the pixel domain. The decoder 100 includes a variable length decoder (VLD) 102, an inverse quantization (IQ) module 104, an inverse discrete-cosine transform (IDCT) module 106, an adder 108, a motion compensation module 110, a frame buffer 112, and a rounding module 114, mutually connected as illustrated. Compressed video (i.e. data which is of the DCT domain) is input at the VLD 102, prediction error blocks are output from the IDCT module 106, and motion compensated blocks are output from the adder 108 as is well-known in the art. The reference blocks used in motion compensation are made accurate to the sub-pixel level by the rounding module 114, without which drift error would occur. Since the decoder 100 operates in the pixel domain it represents the ideal situation.

Please refer to FIG. 2, which is a block diagram of a video decoder 200 for motion compensation in the transform domain. The decoder 200 includes a VLD 202, an IQ module 204, an adder 206, an IDCT module 208, a transform-domain motion compensation module 210, and a frame buffer 212, mutually connected as illustrated. In contrast to the decoder 100 of FIG. 1, the IDCT module 208 is at the output of the decoder 200 rather than just after the IQ module 104. Thus, motion compensation is performed on signals still in the transform domain. This is generally advantageous and tends to lower processor, bandwidth, and power requirements, however, one issue arises: rounding. Element 214 in FIG. 2 shows where a rounding module should be provided, however, the actual rounding provided by the pixel domain rounding module 114 has no existing counterpart for the transform domain. Without precise rounding, drift error occurs, drift error being an accumulation of small errors or imperceptible image artifacts into noticeable defects in the video. In digital video systems this can mean color and shape distortion over a series of frames. Sometimes drift error is tolerable, however, drift error is usually noticeable and disliked by viewers.

At the heart of this problem is the fact that rounding is a nonlinear operation that is not mathematically commutative with the DCT operation. Specifically, when rounding is defined as addition of 0.5 followed by truncation (i.e. setting the fractional part of a number to zero, e.g.: 4.6 —>4.0), the truncation operation is what is not commutative. This means that truncation can only be performed on values in the pixel domain. There is no known transform-domain operation that is equivalent to truncation in the pixel domain. Mathematically, this problem can be illustrated as follows:

In the pixel domain, the rounding operation is as:

$$Truncate ( \vert \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34} \\ {p}_{41} & {p}_{42} & {p}_{43} & {p}_{44}\end{matrix} \vert + \vert \begin{matrix}0.5 & 0.5 & 0.5 & 0.5 \\ 0.5 & 0.5 & 0.5 & 0.5 \\ 0.5 & 0.5 & 0.5 & 0.5 \\ 0.5 & 0.5 & 0.5 & 0.5\end{matrix} \vert ) \qquad ( 1 )$$

where p is a pixel value, which may represent a visual property of a pixel such as hue, brightness, etc.

In the transform domain, the rounding operation is as:

$$DCT ( Truncate ( \vert \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34} \\ {p}_{41} & {p}_{42} & {p}_{43} & {p}_{44}\end{matrix} \vert + \vert \begin{matrix}0.5 & 0.5 & 0.5 & 0.5 \\ 0.5 & 0.5 & 0.5 & 0.5 \\ 0.5 & 0.5 & 0.5 & 0.5 \\ 0.5 & 0.5 & 0.5 & 0.5\end{matrix} \vert ) ) \qquad ( 2 )$$

The truncation operations cannot be performed on DCT values, meaning that the positions of the above operations “DCT” and “Truncate” cannot be reversed. In practical application, this means that transform domain values must be converted back into pixel domain values in order to perform rounding. Thus, the element 214 of FIG. 2 would have to include a IDCT element, a rounding element, and a DCT element to provide the adder 206 with the expected rounded values. This is not practical from the computational efficiency point of view.

The two main prior art solutions to this problem are ignoring rounding completely and ignoring the truncation part of rounding, however, these amount to little more than avoidance of the problem. Drift error still occurs.

### SUMMARY OF THE INVENTION

It is therefore a primary objective of the invention to provide a method for transform-domain rounding in a decoder and such a decoder to solve the above problem.

Briefly summarized, the invention includes performing transform-domain motion compensation on a block according to a motion vector to generate a motion-compensated block, determining a transform-domain offset with reference to the motion vector, adding the transform-domain offset to the motion-compensated block to obtain an addition result, and outputting the addition result as a rounded reference block.

According to the invention, a video decoder includes a variable length decoder (VLD) having an input for receiving compressed video, an inverse quantization (IQ) module having an input coupled to a first output of the VLD, a first adder having a first input coupled to an output of the IQ module, a frame buffer having an input coupled to an output of the first adder, a transform-domain motion compensation module having a first input coupled to a second output of the VLD and a second input coupled to an output of the frame buffer, a second adder having a first input coupled to an output of the transform-domain motion compensation module and having an output coupled to a second input of the first adder, and an offset calculation module having an input coupled to the second output of the VLD and having an output coupled to a second input of the second adder. The offset calculation module outputs a transform-domain offset with reference to a motion vector output by the VLD.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a conventional decoder for motion compensation in a pixel domain.

FIG. 2 is a block diagram of a conventional decoder for motion compensation in a transform domain.

FIG. 3 is a schematic diagram of a rounding application according to the invention.

FIG. 4 is a schematic diagram of a rounding operation according to the invention.

FIG. 5 is a block diagram of a decoder for motion compensation in a transform domain according to the invention.

FIGS. 6-7 are graphs showing simulation results of the invention contrasted with results of the prior art.

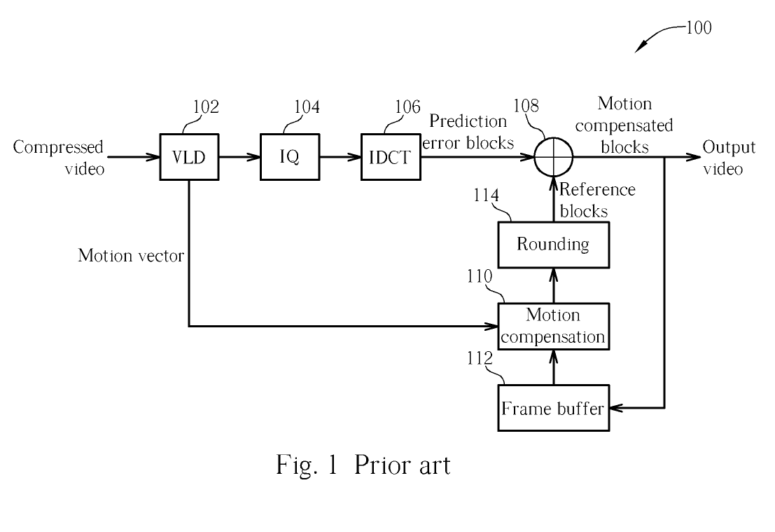

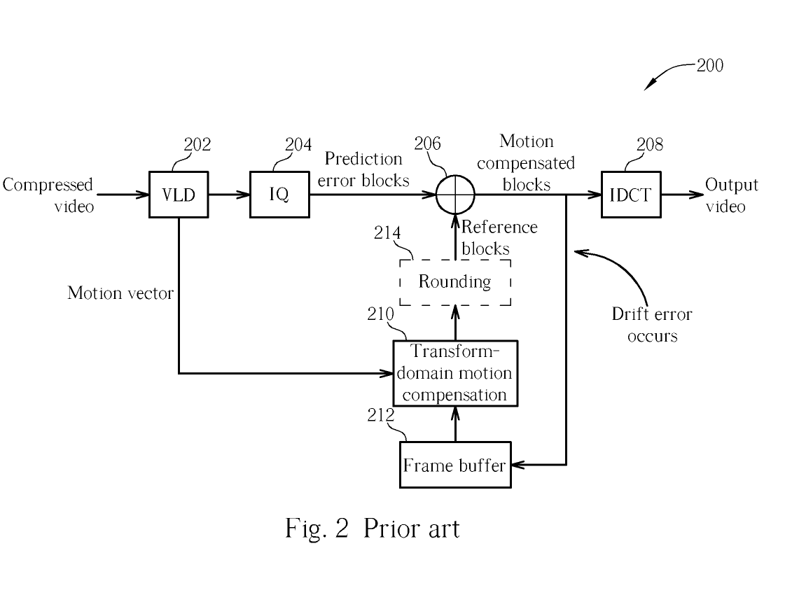

### DETAILED DESCRIPTION

The invention is described in terms of digital video, however, this application does not limit other possible applications for the invention. Also, although the transform domain referenced is of the discrete cosine transform (DCT), other transform domains are also applicable.

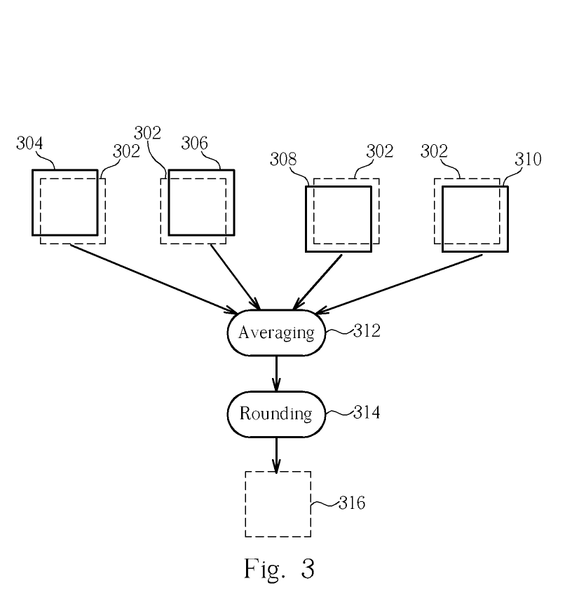

Please refer to FIG. 3, which shows a schematic diagram of a rounding application according to the invention. The process of FIG. 3 is part of a motion compensation process common in Moving Picture Experts Group (MPEG) video playback. Pixel values of a reference block 302 of a video image are required to be calculated. The pixels concerned are those within the square reference block 302 which for the sake of an example, is assumed to be 4 pixels by 4 pixels in size. The reference block 302 is offset from a first source block by 0.5 pixels to the right and 0.5 pixels downward. Since the reference block 302 is offset, three additional source blocks 306, 308, and 310 are required. It can be seen that the regions of the source blocks 304, 306, 308, and 310 cumulatively completely fill the reference block, thereby affording each pixel of the reference block adequate pixel data.

The pixel values of the reference block 302 are calculated by averaging the pixels values of the source blocks 304, 306, 308, and 310. This averaging step 312 involves a summation followed by a divide-by-4 operation for each pixel value due to the fact that there are four source blocks 304, 306, 308, and 310. That is, each pixel value of the reference block 302 is an average of four components, one from each of the source blocks 304, 306, 308, and 310. Should there be fewer or more source blocks or should the averaging be somewhat different than described, the division could involve another divisor. Typical divisors are 4, 8, and 16, although any integer is acceptable. The result of the summation part of the averaging step 312 is typically an integer, while the result of the division part of the averaging step 312 can have floating point precision.

Following the averaging step 312 is a rounding step 314. The rounding step 314 of the invention, which is broken into five steps that are described in the pixel domain for convenience, is as follows. First, a finite set of possible fractional values corresponding to an integer (result of the summation part of the averaging step 312) undergoing division by the divisor is determined. This means that all possible right-of-the-decimal values for division are calculated. These values can be pre-calculated and stored in a information retrieval system such as a lookup table. For example, if the divisor is 4, the corresponding fractional values are of the set {0, 0.25, 0.5, 0.75}. That is, any integer divided by 4 will have a decimal value of this set (e.g. 12/4=3.0, 13/4=3.25, 14/4=3.5, 15/4=3.75, 16/4=4.0, etc.).

Second, a set of possible rounded values of the set of possible fractional values is determined according to a rounding rule. Continuing the example, when the rounding rule is to add 0.5 and then truncate (i.e. to remove a fractional part), which is commonly known as rounding up when greater than or equal to 0.5 and rounding down otherwise, the set of possible rounded values corresponding to the set of fractional values is {0, 0, 1, 1}, i.e., truncate(0+0.5)=0, truncate(0.25+0.5)=0, truncate(0.5+0.5)=1, truncate(0.75+0.5)=1.

Third, a set of possible difference values is calculated. Each difference value is a possible fractional value subtracted from a corresponding possible rounded value. The set of possible difference values is thus {0, −0.25, 0.5, 0.25}. For example, if the original value is 13/4=3.25, then the rounded value is 3.0 and the difference between the original value and the rounded value is −0.25.

Mathematically, the first through third steps can be expressed as a probability function. Specifically, assuming that actual rounding differences are randomly described in the set of possible difference values, a discrete uniform function (or probability mass function) can be used to describe rounding:

$${P}_{R} ( r ) = \frac{1}{4} δ ( r + 0.25 ) + \frac{1}{4} δ ( r ) + \frac{1}{4} δ ( r - 0.25 ) + \frac{1}{4} δ ( r - 0.5 ) \qquad ( 3 )$$

where

P is the probability of R, which is a random variable representing the value difference before and after rounding; and

δ( ) is an impulse function.

In the fourth step, it can be determined that a value, s, such that the expectation of the mean square error (R−s)² denoted by E[(R−s)²] is minimum, is equal to the expectation of R (i.e. E[R]). Therefore, the value difference before and after rounding can be approximated by the expectation of R, E[R]. This result can also be achieved by simply taking the average of the set of difference values {0, −0.25, 0.5, 0.25}. The end result is that rounded values can be approximated by adding expectation E[R] to original values. Continuing with the example, the expectation E[R] can be calculated as [0+(−0.25)+0.5 +0.25]/4=0.125. That is, for a series of original values, the average change in value upon rounding is 0.125. The fourth step is in essence calculating an average value of the set of possible difference values.

Practically, the first through fourth steps can be pre-calculated and stored in a memory device or the like. So, for instance, if a device according to the invention is congruent with the example and operates in the pixel domain, such a memory need only store the pixel domain value 0.125 as a constant.

The fifth step is adding the average value to each value of the set of original values. Mathematically this looks as such:

$$\vert \begin{matrix}{p}_{11} & {p}_{12} & {p}_{13} & {p}_{14} \\ {p}_{21} & {p}_{22} & {p}_{23} & {p}_{24} \\ {p}_{31} & {p}_{32} & {p}_{33} & {p}_{34} \\ {p}_{41} & {p}_{42} & {p}_{43} & {p}_{44}\end{matrix} \vert + \vert \begin{matrix}s & s & s & s \\ s & s & s & s \\ s & s & s & s \\ s & s & s & s\end{matrix} \vert \qquad ( 4 )$$

where

p is a pixel value, which may represent a visual property of a pixel such as hue, brightness, etc; and

s is the average value as previously determined (e.g. 0.125).

Thus, by adding carefully chosen constant value, s, to the pixel values, p, rounding can be approximated in the pixel domain with exceptional accuracy. The result is a reference block 316 of high accuracy, as shown in FIG. 3.

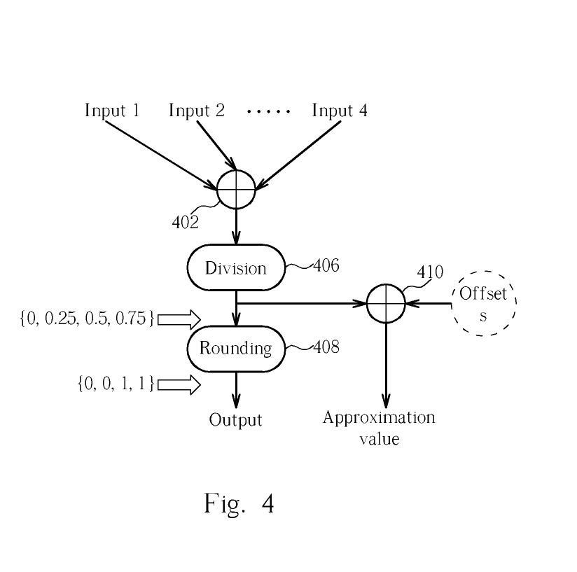

Please refer to FIG. 4, which shows a schematic diagram of a rounding operation according to the invention. Input 1-Input 4 (more or fewer are also acceptable) provide pixel values to an adder 402. Division is then processed at 406, after which, true rounding (i.e. involving truncation) could be performed at 408. However, according to the invention, an offset, s, is simply added at an adder 41 0. Thus, an approximation of the rounded output is achieved. Using this approximation for rounding in the transform domain, the mean squared error is minimized, as shown above mathematically. Moreover, if the divisor is known in advance (which is usually the case) and assuming a uniform distribution as mentioned, the expectation or offset, s, can be pre-computed.

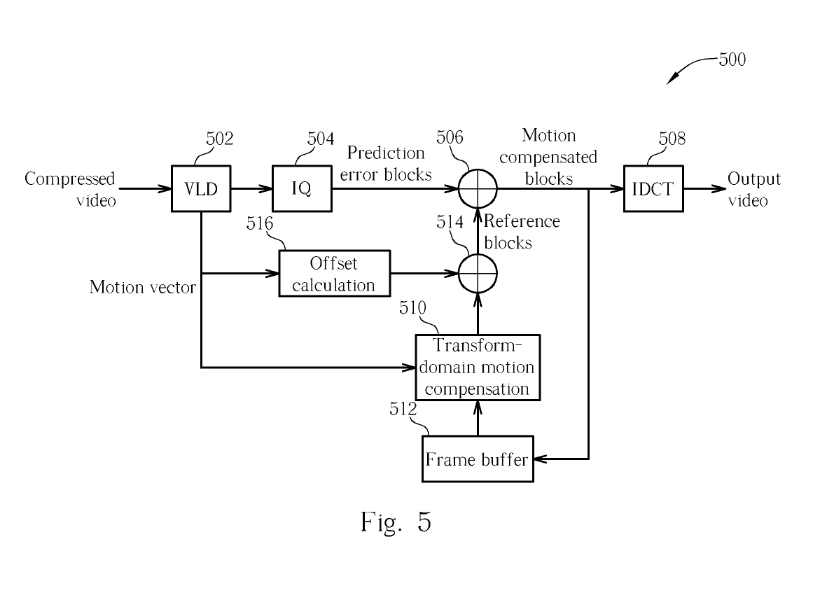

In contrast to the prior art, the above-described rounding operation does exist in the transform domain. Please refer to FIG. 5, which is a block diagram of a decoder 500 for motion compensation in a transform domain according to the invention. The decoder 500 comprises a variable length decoder (VLD) 502 having an input for receiving compressed video, an inverse quantization (IQ) module 504 having an input coupled to a first output of the VLD 502, a first adder 506 having a first input coupled to an output of the IQ module 504, and a frame buffer 512 having an input coupled to an output of the first adder 506. The decoder 500 further comprises a transform-domain motion compensation module 510 having a first input coupled to a second output of the VLD 502 and a second input coupled to an output of the frame buffer 512, a second adder 514 having a first input coupled to an output of the transform-domain motion compensation module 510 and having an output coupled to a second input of the first adder 506, and an offset calculation module 516 having an input coupled to the second output the VLD 502 and having an output coupled to a second input of the second adder 514. Lastly, the decoder 500 comprises an inverse discrete-cosine transform (IDCT) module 508 coupled to the output of the first adder 506 and for outputting video. The invention also provides a transcoder with the same structure as above less the IDCT module 508. The decoder 500 takes prediction error blocks and turns them into motion compensated blocks using reference blocks and a motion vector, as is well-known in the art. However, according to the invention, the decoder 508 further performs the above-described offset rounding approximation in the transform domain by way of the offset calculation module 516.

The offset calculation module 516 contains instructions or data that result in the transform-domain equivalent of the above-described first through fourth steps. In more straightforward embodiments, as is preferred, this can mean that the offset calculation module 516 is a lookup table, realized by a memory or similar device, that outputs the appropriate offset for a given motion vector (different offsets are needed since different motion vectors correspond to different divisors). In more complex embodiments it may be desirable to perform one or more of the first through fourth steps as real-time calculations.

Since the decoder 500 is of the transform domain, the offset calculation module 516 need only store transform domain offset values equivalent to the expected pixel domain offsets. The adder 514 then combines the transform domain offset values with the output of the transform-domain motion compensation module 510. For example, if the expected motion vectors have 0.5-pixel resolution, the offset calculation module 516 would store the following offsets:

$$\begin{matrix}\vert \begin{matrix}1 & 0 & 0 & 0 \\ 0 & 0 & 0 & 0 \\ 0 & 0 & 0 & 0 \\ 0 & 0 & 0 & 0\end{matrix} \vert for the motion vectors ( 0.5 , 0 ) or ( 0 , 0.5 ) , \\ and & ( 5 ) \\ \vert \begin{matrix}1 / 2 & 0 & 0 & 0 \\ 0 & 0 & 0 & 0 \\ 0 & 0 & 0 & 0 \\ 0 & 0 & 0 & 0\end{matrix} \vert for the motion vector ( 0.5 , 0.5 ) & ( 6 )\end{matrix}$$

The motion vectors (0.5, 0) or (0, 0.5) only require a divisor of 2. This is because a reference block shifted by one of these motion vectors would only ever overlap two source blocks. Likewise, the motion vector (0.5, 0.5) would result in a divisor of 4 since the reference block would overlap 4 source blocks as in the above example (see FIG. 3). The matrixes (5) and (6) are the corresponding rounding offsets in the transform domain, the matrix (6) corresponding to the previously mentioned pixel-domain offset example of 0.125. Thus, the rounding approximation can be achieved in the transform domain, by the following:
X+D=Y (7)

where

X is a block (matrix) of transform-domain values before rounding;

D is a transform-domain rounding offset, such as matrix (5) or (6) above; and

Y is a rounded result in the transform domain, equivalent to the pixel-domain result of (4).

It should be noted that the size of these blocks is arbitrary, 4 by 4 being merely an example. Other typical block sizes are 8 by 8 and 16 by 16.

Hence, the decoder 500 comprising offset calculation module 516, which has a lookup table or similar with the matrixes (5) and (6) stored inside, and comprising the adder 514 is capable of performing rounding in the transform domain. The offset calculation module 516 encompasses the first through fourth steps described above while the adder 514 performs an equivalent of the fifth step. The output of the adder 514 are transform-domain reference blocks that have undergone rounding of pixel values. Thus rounding is accomplished in the transform domain.

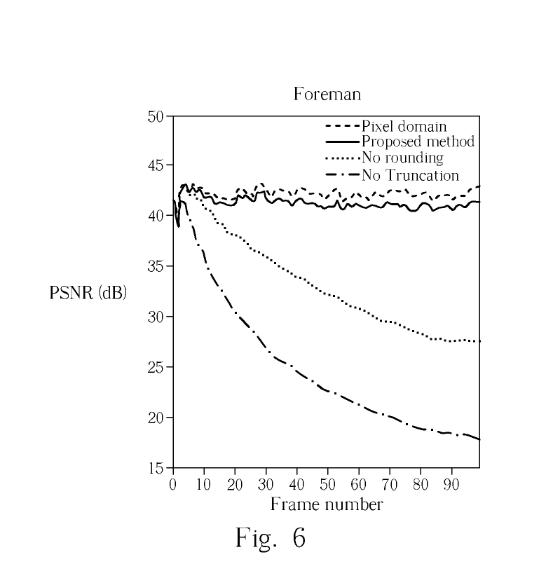

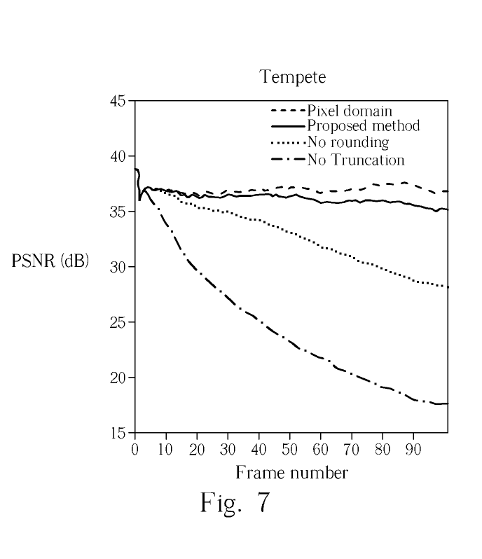

FIGS. 6-7 are graphs showing simulation results of the invention. Shown are peak signal-to-noise ratio (PSNR) plots of decoded video (using the Foreman and Tempete sequences). The curves are the pixel domain as a reference, the invention as described above, and two prior art transform-domain methods: without rounding and without truncation (only addition of 0.5). It can be clearly seen that the invention offers a transform rounding approximation that is superior to the prior art.

In summary, according to the invention, the offset calculation module 516 stores transform domain offset values equivalent to the expectations of the pixel domain offsets for a group of motion vectors. These transform domain offset values are preferably stored in a lookup table of a memory or similar device. The adder 514 combines the transform domain offset values with the output of the transform-domain motion compensation module 510. Thus, true rounding can be realistically approximated in the transform domain. In contrast to the prior art, the present invention offers accurate and practical rounding in the transform domain.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for transform-domain rounding in a decoder, the method comprising:
performing transform-domain motion compensation on a block according to a motion vector to generate a motion-compensated block;
determining a transform-domain offset with reference to the motion vector;
adding the transform-domain offset to the motion-compensated block to obtain an addition result; and
outputting the addition result as a rounded reference block.

2. The method of claim 1, wherein determining the transform-domain offset with reference to the motion vector comprises looking up a pre-calculated transform-domain offset stored in a lookup table.

3. The method of claim 2, wherein a plurality of pre-calculated transform-domain offsets are stored in the lookup table, each transform-domain offset corresponding to a motion vector.

4. The method of claim 2, wherein the transform-domain offset is a transform-domain equivalent of an average pixel-domain offset as determined by:
determining a finite set of possible fractional values corresponding to division of a summation of pixel values by a divisor;
determining a set of possible rounded values of the set of possible fractional values according to a rounding rule;
determining a set of possible difference values, wherein each difference value is a corresponding possible fractional value subtracted from a corresponding possible rounded value; and
averaging the set of possible difference values to obtain the average pixel-domain offset.

5. The method of claim 4, wherein a plurality of pre-calculated transform-domain offsets are stored in the lookup table, each transform-domain offset corresponding to an average pixel-domain offset and a motion vector.

6. A video decoder comprising:
a variable length decoder (VLD) having an input for receiving compressed video;
an inverse quantization (IQ) module having an input coupled to a first output of the VLD;
a first adder having a first input coupled to an output of the IQ module;
a frame buffer having an input coupled to an output of the first adder;
a transform-domain motion compensation module having a first input coupled to a second output of the VLD and a second input coupled to an output of the frame buffer;
a second adder having a first input coupled to an output of the transform-domain motion compensation module and having an output coupled to a second input of the first adder; and
an offset calculation module having an input coupled to the second output the VLD and having an output coupled to a second input of the second adder, the offset calculation module outputting a transform-domain offset with reference to a motion vector output by the VLD.

7. The video decoder of claim 6, wherein the offset calculation module comprises a lookup table relating motion vectors to transform-domain offsets.

8. The video decoder of claim 7, wherein each transform domain offset comprises a transform domain equivalent of a pre-calculated average of a set of possible difference values, wherein each difference value is a possible fractional value subtracted from a corresponding possible rounded value, wherein the possible fractional values are fractional values corresponding to division of a summation of pixel values by a divisor and the possible rounded values are possible fractional values rounded according to a rounding rule.

9. The video decoder of claim 6, further comprising a inverse discrete cosine transform (IDCT) module having an input coupled to the output of the first adder.
